(19) United States
(12) Patent Application Publication
(10) Pub. No.: US 2002/0090977 A1
(43) Pub. Date: Jul. 11, 2002

(54) Automatic signal transfer apparatus for mobile phone

(75) Inventor: Gordon Chen, Hsin Tien City (TW)

Correspondence Address: Bruce H. Troxell, DOUGHERTY & TROXELL, Suite 1404, 5205 Leesburg Pike, Falls Church, VA, 22041, US

(73) Assignee: Syagration Ltd.

(21) Appl. No.: 09/755,033

(22) Filed: Jan. 8, 2001

(51) Int. Cl. H04M 1/00

(52) U.S. Cl. 455/557

(57) ABSTRACT

Automatic signal transfer apparatus for mobile phone is composed of an interface circuit, a transmitter/receiver signal transfer circuit, a DC power supply circuit, a line state detection circuit, a change over control circuit, a change over device, and a ringing circuit. With this structure the apparatus is able to automatically identify whether the input signal comes from the commercial telecom line, or from the mobile phone, and automatically transfers to the indoor telephone. By so, in order to receive both calling coming from the telecom line and calling to the mobile phone, and transfer the callings to the indoor telephone set without going through a tedious presetting procedure, it is only required to connect the mobile phone to an interface circuit. With such scheme, the apparatus of the present invention will never affect function and operation of the indoor telephone.

### BACKGROUND OF THE INVENTION

(1) Field of the Invention

The present invention relates to automatic signal transfer apparatus for mobile phone, and more particularly, to an apparatus which can automatically transfer input signal of a mobile phone to the commercial telecom line such that an user is able to receive a telephone call coming to the mobile phone with the commercial telephone.

(2) Description of the Prior Art

Keeping pace with freeing telecommunication act, mobile phones become more and more commonly used in United States even to the extent that almost everyone owns one unit. It is a common habit that after returning to his/her home, the user put the mobile phone unit under charging in stead of caring it at hand. In an average indoor the mobile phone is difficult to receive incoming signal unless it is located at the door entry or near a window. People use domestic telephone regularly when staying at home in stead of the mobile phone. In the case there comes a calling signal to the mobile phone, its ringing sound is always neglected. A mobile phone is thus no chance to service at home. If at this time the input signal to the mobile phone can be automatically switched to each extension of the indoor telephone, the mobile phone may assist to enhance function of communication for the home.

In order to overcome the inconvenience to a mobile phone described above, the present invention has delved into this matter with a long time effort and came to realization of the present invention.

### SUMMARY OF THE INVENTION

It is a first object of the present invention to provide automatic signal transfer apparatus for mobile phone which can switch input signal of the mobile phone to the commercial telecom line such that an user is able to receive a telephone call coming to the mobile phone with the commercial telephone so that both mobile phone and the indoor telephone can be conveniently cooperated.

It is a second object of the present invention to provide automatic signal transfer apparatus for mobile phone wherein the mobile phone can be put at a place having stronger intensity of signal such that the indoor telephone can be used to communicate with a calling to the mobile phone.

It is a third object of the present invention to provide automatic signal transfer apparatus for mobile phone which is so elaborately, practically, and innovatively designed that the call to the mobile phone can be automatically transferred to the domestic indoor telephone without the need of manual switching, or tedious presetting procedure only if the mobile phone is connected to an interface circuit of the present invention.

These and other objects of the present invention are achieved by an automatic signal transfer apparatus for mobile phone comprising a mobile phone interface circuit, a transmitter/receiver signal transfer circuit, a DC power supply circuit, a line state detection circuit, a change over control circuit, a change over device, and a ringing circuit. With this structure the apparatus is able to automatically identify whether the input signal comes from the commercial telecom line, or from the mobile phone and automatically transfer to the indoor telephone. By so, in order to receive both callings coming from the commercial telecom line and calling to the radio mobile phone and transfer the callings to the indoor telephone set without going through a tedious presetting work, it is only required to connect the mobile phone to an interface circuit. With such scheme the automatic signal transfer apparatus of the present invention will never affect function and operation of the indoor telephone.

### BRIEF DESCRIPTION OF THE DRAWINGS

For fuller understanding of the nature and objects of the invention, reference should be made to the following detailed description taken in conjunction with the accompanying drawings in which:

FIG. 1 is a block diagram of automatic transfer signal apparatus for mobile phone of the present invention;

FIG. 2 is an operational flow chart of the electrical circuits constituting the present invention; and

FIG. 3 is the circuit layout of T/R signal transfer circuit in an embodiment of the present invention.

### DETAILED DESCRIPTION OF THE PREFERRED EMBODIMENT

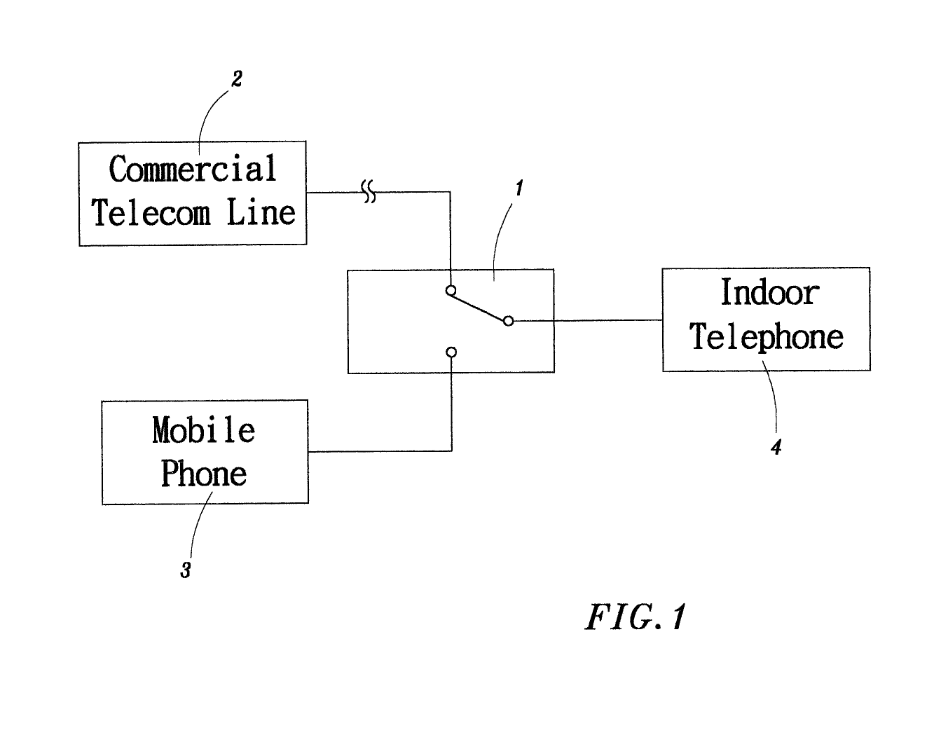

Referring to FIG. 1, the drawing shows a block diagram of the present invention. An automatic transfer unit 1 can automatically identify whether the input signal is a calling signal coming from a telecom line 2, or an calling signal to the mobile phone 3, and then transfer this calling signal to an indoor telephone 4 In other word, the apparatus enables the indoor telephone 4 to receive both callings from the telecom line 2 and to the radio mobile phone 3.

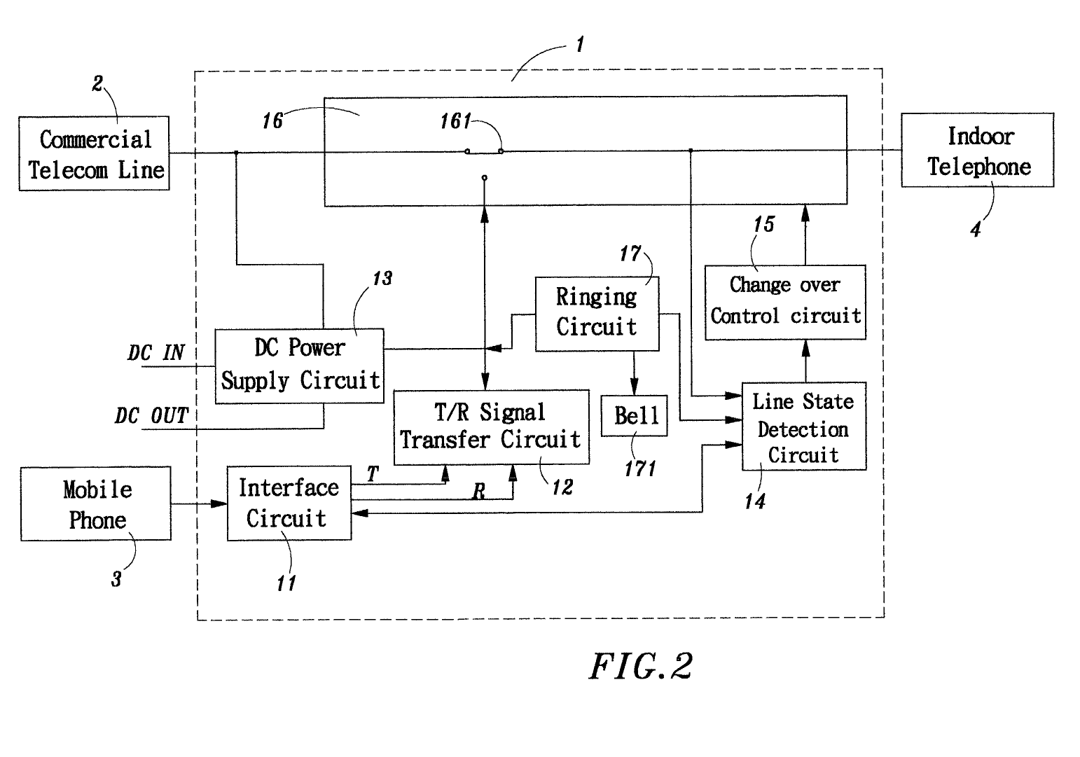

Referring to FIG. 2, the drawing is an operational flow chart of the electrical circuits constituting the apparatus of the present invention. The circuit of the automatic transfer apparatus comprises a mobile phone interface circuit 11, a transmitter/receiver (T/R) signal transfer circuit 12, a DC power supply circuit 13, a line state detecting circuit 14, a change over control circuit 15, a change over device 16, and a ringing circuit 17. The mobile phone interface circuit 11 is connected to the mobile phone 3. The interface circuit 11 is connected to the terminals of earphone, microphone and battery charging unit of the mobile phone 3. T/R signal transfer circuit 12 is for transferring T/R signal to the mobile phone 3 to that to the indoor telephone 4. Owing to the fact that the transmission mode of the radio mobile phone 3 is completely different from that of the wired city telecom system, therefore, in the present invention the earphone and the microphone of the mobile phone 3 is used to transform voice signal into T/R signal acceptable for the indoor telephone 4 so that the indoor telephone 4 and the mobile phone 3 can cooperatively operate by such signal transformation. The DC power supply circuit 13 is for charging the mobile phone 3 and supplying DC energizing power to the apparatus of the present invention. The line state detection circuit 14 is for detecting whether the indoor telephone 4 is on line or not, in other word, to detect if the receiver of the indoor telephone 4 is off hook, and also for detecting if there is a calling signal coming to the mobile phone 3. The change over control circuit 15 receives signal of the line state detected by the detection circuit 14 so as to actuate the change over device 16 to change over the line connection of the indoor telephone 4 if necessary. The ringing circuit 17 is responsible for receiving bell signal of the mobile phone 3 and transforming it to a bell signal for the indoor telephone 4. The operational principle of the electrical circuits according to the present invention shown in FIG. 2 will be illustrated as follows: The DC power supply circuit 13 supplies an uninterrupted DC power for charging the mobile phone 13. The line state detection circuit 14 restlessly detects if there is a ringing signal to the mobile phone 3. If the answer is yes, the circuit 14 then detects whether the indoor telephone 4 is in use or not, in case it is on hook, a signal is sent to the change over control circuit 15 to operate a line switch 161 in the change over device 16 to switch the indoor telephone 4 to the mobile phone side of the T/R signal transfer circuit 12 so as to receive the signal transmitted from the mobile phone 3. Meanwhile, the mobile phone interface circuit 11 transmits a bell signal of the mobile phone 3 to the ringing circuit 17 simultaneously thereby the ringing circuit 17 sends a bell signal on the telecom line which is acceptable to the indoor telephone 4 for ringing.

As the indoor telephone 4 rings after receiving aforementioned bell signal from the mobile phone 3, the detection circuit 14 carries on detection work as to whether the receiver of the indoor telephone 4 is off hook or not, if the answer is yes, then the detection circuit 14 delivers a signal to the mobile phone interface circuit 11 informing this state so as to instruct the mobile phone 3 to receive the call, and the voice signal is inputted to the earphone and the microphone of the mobile phone 3 and is transformed to T/R signal acceptable to the indoor telephone 4 through T/R signal transfer circuit 12 thereby the communication can be carried out by the indoor telephone 4 instead of using the mobile phone 3.

As soon as the communication is over, the detection circuit 14 detects that the receiver of the indoor telephone 4 is on hook, and immediately sends an on hook signal to the mobile phone interface circuit 11 thereby cutting off the communication over the mobile phone 3, and at the same time by sending a change over signal to the change over control circuit 15 so as to switch the line switch 161 of the change over device 16 into telecom line thereby restoring the system to the mode of connecting to the telecom line.

As mentioned above, the DC power supply circuit 13 is for supplying DC current to the electrical circuits of the present invention and for serving as a charging source for the mobile phone battery unit as well. In case the DC power supply circuit 13 loses its DC source, it is able to introduce the power from the telecom line and supply the circuits of the present invention with required DC working power through necessary transformation. In the meanwhile, a buzzer or a bell can be equipped with the ringing circuit 17 for informing a call is coming to the mobile phone 3 without ringing the indoor telephone 4.

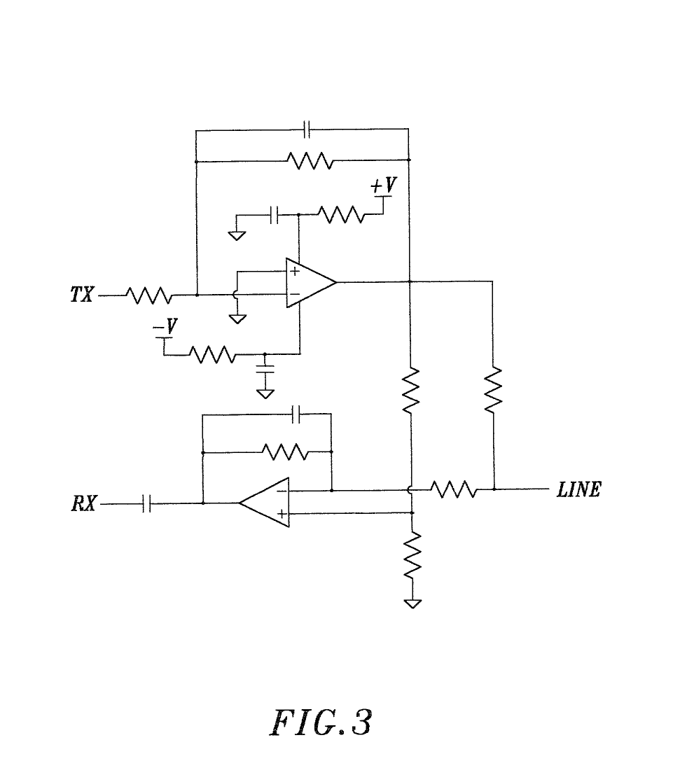

Referring to FIG. 3, wherein the circuit layout of T/R signal transfer circuit in an embodiment of the present invention is shown. As there is difference between transmission signal acceptable for the mobile phone 3 and that for the indoor telephone 4, therefore, in the pleasant invention the voice signal inputted to the earphone and the microphone is transformed to T/R signal acceptable to the indoor telephone through the T/R signal transfer circuit 12 such that the indoor telephone 4 can receive the telephone call to the mobile phone 3. In the present invention, the mobile phone 3 and the indoor telephone 3 is interconnected via the interface circuit 11 by connecting the earphone terminals and the microphone terminals of the mobile phone 3 with the interface circuit 11. The voice signal inputted from the mobile phone 3 is transformed to T/R signal acceptable to the indoor telephone 4 by the T/R signal transfer circuit constituted by an operational amplifier and through a route from the earphone terminal to the input terminal(TX), the T/R signal transfer circuit 12, and to the telecom line of the indoor telephone 4 thereby enabling the indoor telephone 4 to communicate with the another side. Reversibly, T/R signal from the indoor telephone 4 is transformed to a voice signal acceptable for the mobile phone 3 through the route from the telecom line, the T/R signal transfer circuit 12, output terminal (RX) of the circuit 12, and to the microphone terminal of the interface circuit 11 thereby enabling the mobile phone 3 to communicate with another side.

For conclusion, the apparatus of the present invention has some novel features which cannot be neglected:

1. The apparatus of the present invention can be set at a comparatively good signal receivable place so as to eliminate signal dead angle to a mobile phone when it is put indoor.

2. Communication can be carried out by using the indoor telephone when the mobile phone is on charging.

3. Radio mobile phone and telecom line are interconnected so that a calling from outside can be answered either with the indoor telephone or with the mobile phone especially convenient to a place where many extensions are installed or radio mobile phones are used.

4. Tedious manual or automatic switching procedures are eliminated so as to save additional cost so far the mobile phone is connected to the apparatus of the present invention without the fear of degrading the function of indoor telephone or affecting its operation.

Those who are skilled in the art will readily perceive how to modify the invention. Therefore, the appended claims are to be constructed to cover all equivalent structures which fall within the true scope and spirit of the invention.

What is claimed is:

1. Automatic signal transfer apparatus for mobile phone comprising:
a mobile phone interface circuit for connecting to terminals of an earphone, a microphone interface circuit for connecting to terminals of an earphone, a microphone and a charging battery unit of the mobile phone;
a T/R (Transmitter/Receiver) signal transfer circuit for transforming a voice signal to the mobile phone to a T/R signal acceptable to an indoor telephone connected to the telecom line;
a DC power supply circuit for supplying DC power to all electrical circuits of said apparatus and the indoor telephone;
a line state detection circuit for detecting whether the indoor line is on line or not, and also for detecting if there is a calling signal to the mobile phone;
a change over control circuit for receiving signal from said line state detection circuit informing the line state so as to change over the line connection;
a change over device for changing the line connection to the mobile phone side or to the telecom line side; and
a ringing circuit responsible for receiving bell signal of the mobile phone and transforming it into a bell signal for the indoor telephone;
with such a scheme of the circuits, a voice signal inputted to the mobile phone is transformed to T/R voice signal acceptable for the indoor telephone by said T/R signal transfer circuit through earphone and microphone terminals of the mobile phone thereby realizing the transformation between voice signal of the mobile phone and T/R signal of the indoor telephone.

2. The apparatus as claimed in claim 1, wherein said DC supply circuit is usable for charging the mobile phone.

3. The apparatus as claimed in claim 1, wherein the operation principle of said electrical circuit is: said line state detection circuit restlessly detects if there is a ringing signal to the mobile phone, if the answer is yes, said detection circuit then detects whether the indoor telephone is in use or not, in case it is on hook, a signal is sent to said change over control circuit to operate a line switch in said change over device to switch the indoor telephone to the mobile phone side of said T/R signal transfer circuit so as to receive the signal transmitted from the mobile phone, said mobile phone interface circuit transmit a bell signal of the mobile phone to said ringing circuit which in turn sends a bell signal to the indoor telephone for ringing.

4. The apparatus as claimed in claim 3, wherein if the indoor telephone is detected to be on hook in use, said change over control circuit never sends any change over signal to said change over device such that the indoor telephone stays continually in telecom line.

5. The apparatus as claimed in claim 1, wherein the response of said electrical circuit to a call to the mobile phone including, said ringing circuit outputs a bell signal for ringing the indoor telephone; said line state detection circuit detects whether the indoor telephone is in use or not, if it is yes, said detects circuit then sends a signal to said mobile phone interface circuit to instruct the mobile phone to receive the calling; the input voice signal to the mobile phone is transformed into T/R signal acceptable to the indoor telephone by said T/R signal transfer circuit and transferred from the earphone and the microphone terminals to the indoor telephone.

6. The apparatus as claimed in claim 1, wherein steps of ending a telephone call by said electrical circuits includes: detecting that the indoor telephone has been hung on by said line state detection circuit; sending a hang on signal to said interface circuit to interrupt the mobile phone communication by said detection circuit; sending a change over signal from said detection circuit to said change over control circuit to operate said change over device thereby switching the line connection back to the telecom line therefore restoring the indoor telephone to its normal operation mode.

7. The apparatus as claimed in claim 1, wherein said DC power supply circuit is directly connected to a DC source, in case said DC power supply circuit loses its DC source, said DC power supply circuit is able to introduce the power from the telecom line and supply said electrical circuit of said apparatus with required DC working power through necessary transformation.

8. The apparatus as claimed in claim 1, wherein a buzzer or a bell can be equipped with said ringing circuit for informing a call is coming to the mobile phone without ringing the indoor telephone.
